(19) United States
(12) Patent Application Publication
(10) Pub. No.: US 2006/0159026 A1
(43) Pub. Date: Jul. 20, 2006

(54) Method and apparatus for managing a quality of service for a communication link

(75) Inventors: Xidong Wu, Livermore, CA (US); Ganesh Krishnamuthi, Danville, CA (US); Raghvendra G. Savoor, Walnut Creek, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/036,465

(22) Filed: Jan. 14, 2005

(51) Int. Cl. H04L 12/26; H04L 12/28

(52) U.S. Cl. 370/252; 370/235; 370/395.21

(57) ABSTRACT

A method and apparatus for managing the quality of a communication link is provided. A performance of a communication line (i.e. digital subscriber line), being affected by code violations, typically impulse noise, is estimated. An application characteristic for the communication line is then imputed from Layer 2 and Layer 3 network levels attributes, such as upstream/downstream percentages, IP port usage, ATM cell count. A correlation is made between the performance and the application, and a decision model then applies a maintenance profile the communication line based on the performance and the application. The present invention provides a method and apparatus for managing a quality of service experienced by a user when running an application over a communication link. A performance for the communication link is estimated and an application characteristic for the communication link is imputed from data gathered regarding the communication link performance. A decision model is then applied to select an appropriate maintenance profile for managing the quality of service provided by the communication link. The selected profile is then applied to the communication link based on the performance and the application. Management of the quality of service includes selecting an appropriate profile to provide an acceptable user experience for the application and noise level.

### BACKGROUND OF THE INVENTION

1. Field of the Invention

The present invention relates to the field of data communications. In particular the present invention is a method and apparatus for managing the quality of service a user experiences when running an application over a communication link, such as occurs in broadband communications.

2. Description of the Related Art

Data communications over communication links, such as digital subscriber lines (DSL), and asynchronous DSL (ADSL) lines, which transmit data over existing telephone lines, are configured to particular profiles based on service agreement, loop quality, and operating environment. A change in any one of these factors, such as introduction of outside electromagnetic noise, degrades communication line performance. If the degradation of the communication line is serious, the communication line may become a “problem line” and be subject to a new profile. Within a large network, there may be thousands of communication lines that become problem lines.

The quality of service a user experiences over a broadband communication line is ultimately determined by how much application layer error-free throughput a user achieves over the communication line. ADSL line speed only dictates an up stream limit for an ADSL physical rate. When using ADSL, the speed at which a user can download a file from the Internet over a communication line or the quality and speed of the service of a streaming video down from the Internet is constrained not only by ADSL line speed but also by other factors. These other factors include, among others, the size of the data files the user downloads, the type of user applications in which a user engages (such as, web browsing, streaming video, Voice over Internet Protocol (VoIP) etc.), and the performance of the end user device.

TCP (Transmission Control Protocol) is a set of rules used along with the Internet Protocol (IP) to send data in the form of message units between computers over the Internet. While IP takes care of handling the actual delivery of the data, TCP takes care of keeping track of the individual units of data that a message is divided into for efficient routing through the Internet. TCP and IP are one of many protocols that can be used in and ADSL communications system. Data is generally split into several TCP “packets” and transmitted to a receiving end, at which point the packets are reassembled. If an ADSL line is operating in a noisy environment, then data integrity can be compromised. A code violation is determined one of many methods for checking data integrity that is standard in the industry. One example of determining a code violation would be cyclic redundancy checking, for determining small changes in blocks of data.

If impulse noise impacts a TCP packet, then the TCP packet is dropped and requires retransmission. Depending on round trip time, the retransmission of each TCP packet prolongs the overall TCP transmission, thereby lowering the TCP throughput. If there are excessive amounts of code violations, TCP throughput can be dragged down to close to zero. This analogy also applies to other protocols with different handling. For example, Real-Time Transport Protocol, which transmits multimedia will experience jitter due to packet loss, and File Transfer Protocol (FTP) will experience delay. ADSL modems commonly employ data interleaving, which is a technique to increase resistance to noise bursts on a line. Interleaving “smears” out micro bits of data (interleaves them over time) so that a short burst of signal destroying noise can only remove part of any given larger block. However, use of interleaving to mitigate the line errors can result in latency that impacts applications like Voice over Internet Protocol (VoIP) and associated protocols known or specified in the data communications industry, with subscribers experiencing echo or long delay.

The extent of the impact from code violations an ADSL user experiences is directly correlated to ADSL usage activity (duration, time of day, conditions) and the type of user applications. If code violations indicative of communication errors occur when the user is not using the communication link, the occurrence does not adversely impact the user experience. If the user is actively web-browsing, some low level of code violations can be tolerated without noticeably affecting the web-browsing experience. Only relatively large amounts of code violations can affect the IP layer throughput sufficient to adversely affect the web-browsing experience. However, if the user is engaged in an application such as streaming video, even a small amount of code violations can adversely affect the application and degrade the quality of the video.

Degradation of the quality of the video degrades the quality of service the user experiences while running the streaming video application over the communication link. In another consideration, upstream and downstream code violations affect different applications differently. For example, if a user is uploading files to the Internet or sharing music, video or files on the Internet and his personal computer (PC) is being used as a server, upstream code violations affect the application more than downstream code violations.

The general cause of code violations is impulse noise. Impulse noise can be generated from a wide variety of sources, including electronic equipment within the home. Impulse noises generated within the user's home tend to follow the user's general activity. For example, impulse noise is generated by a hair dryer used in the morning, or by a halogen lamp/dimmer switch turned on in the evening.

The Open Systems Interconnection (OSI) Reference Model is a standard reference model for communication between two end users in a network. The OSI model describes seven layers of related functions that are needed at each end when a message is sent from one party to another party in a network. Included among these layers are the Physical Layer, the Data Link Layer, and the Network Layer, also known as Layer 1, Layer 2, and Layer 3, respectively. The Physical layer supports the electrical or mechanical interface to the physical medium. For example, this layer determines how to put a stream of bits from the upper (data link) layer on to the pins for a parallel printer interface, an optical fiber transmitter, or a radio carrier. The Data-Link layer is the protocol layer that handles the moving of data in and out across a physical link in a network. The Data-Link layer ensures that an initial connection has been set up, divides output data into data frames, and handles the acknowledgements from a receiver that the data arrived successfully. It also ensures that incoming data has been received successfully by analyzing bit patterns at special places in the frames. The Network layer knows the address of the neighboring nodes in the network, packages output with the correct network address information, selects routes and recognizes incoming messages. IP is an exemplary protocol that generally maps to the Network Layer.

Traditional methods of improving ADSL communication links usually look at the ADSL performance parameters (i.e., Physical Layer). None of these traditional methods are directly associated with user activity or with the services and application in which a user is engaged. Currently, ADSL is provided based on using a “best effort” to reduce error counts. These methods are therefore “service layer unaware” or ignorant of the application in which a user is engaged, which could be determined by observing activities at the Data Link Layer and the Network Layer.

The degree to which code violations impact an ADSL user's experience or quality of service during an application depends on the time of occurrence and the type application being used. An ADSL line procedure which can obtain and analyze information relevant to the impact on the user's experience would be more efficient and more accurate. Thus, there is a need for a method and apparatus that addresses the occurrence of code violations at the physical layer as well as user activity and the type of application in which a user is engaged.

### SUMMARY OF THE INVENTION

The present invention provides a method and apparatus for managing a quality of service experienced by a user when running an application over a communication link. A performance for the communication link is estimated and an application characteristic for the communication link is imputed from data gathered regarding the communication link performance. A decision model is then applied to select an appropriate maintenance profile for managing the quality of service provided by the communication link. The selected profile is then applied to the communication link based on the performance and the application. Management of the quality of service includes selecting an appropriate profile to provide an acceptable user experience for the application and noise level.

A typical communication link is a line, which includes a digital subscriber line (DSL). A communication link can also be a wireless communication link. Estimation of the performance of the communication line includes determining an occurrence of errors and code violations at the hardware level. Such errors and code violation are generally attributable to the occurrence of impulse noise on the communication line. Application characteristics are typically determined from observation of the Layer 2 and Layer 3 network levels corresponding to the Open Systems Interconnection (OSI) reference model. Application characteristics, such as the type of application in which a user is engaged can be imputed from the communication link upstream/downstream percentage, IP port usage and asynchronous transfer mode (ATM) cell count. A correlation is performed between ATM cell counts, transmission control protocol (TCP) ports, and line errors. Quality of service management is provided through application of a maintenance profile selected for a particular application. A decision model is applied to select an appropriate maintenance profile to manage the quality of service the user experiences when using the communication link for the application in the presence of impulse noise.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 shows a system in accordance with an embodiment of the present invention;

FIG. 2 shows a profile of upstream and downstream ATM cell counts during a period of downloading activity according to one aspect of the present invention;

FIG. 3 shows a profile of upstream and downstream ATM cell count during a period of uploading activity according to one aspect of the present invention;

FIG. 4 shows the effect of impulse noise on a downstream ATM cell count during file transmission;

FIG. 5 shows the effect of impulse noise on TCP throughput; and

FIG. 6 shows a flowchart functions performed in one example of the present invention.

### DETAILED DESCRIPTION OF THE INVENTION

In view of the above, the present invention through one or more of its various aspects and/or embodiments is presented to provide one or more advantages, such as those noted below.

The present invention presents a method for associating user activity and application type with physical line characteristics. A correlation can be made among the presence of physical line errors with the user activity and application type. The result of the correlation can be used to provide an error correcting profile to address an occurrence of impulse noise on the communication link.

The method of the present invention employs information from at least 3 layers of a network, namely the physical layer, the data-link layer, and the network layer. The present invention correlates line errors obtained from the physical layer, ATM cell counts obtained from the network layer, and TCP port usage information obtained from the network layer. The present invention is sensitive to usage activity at the time of the impulse noise or line impairment and the levels of usage. The usage activity is granular with a historical view (hours, days, etc.) to ensure statistical confidence in decision making. The present invention is also sensitive to the service layer and avoids adversely affecting the service layer by acknowledging those conditions that are not visible at the physical layer.

Just as the quality of service is affected by errors that impact error-free through put, the quality of service is also affected by the profile or error correction applied to a communication link. While a particular error correction profile may reduce errors on the physical level, the error correction profile may adversely affect the quality of service a user experiences while engaged in an application by introducing echo into a voice application. Thus, the present invention provides visibility into the application in which a user is engaged, and takes the application into account and rather than just the error count.

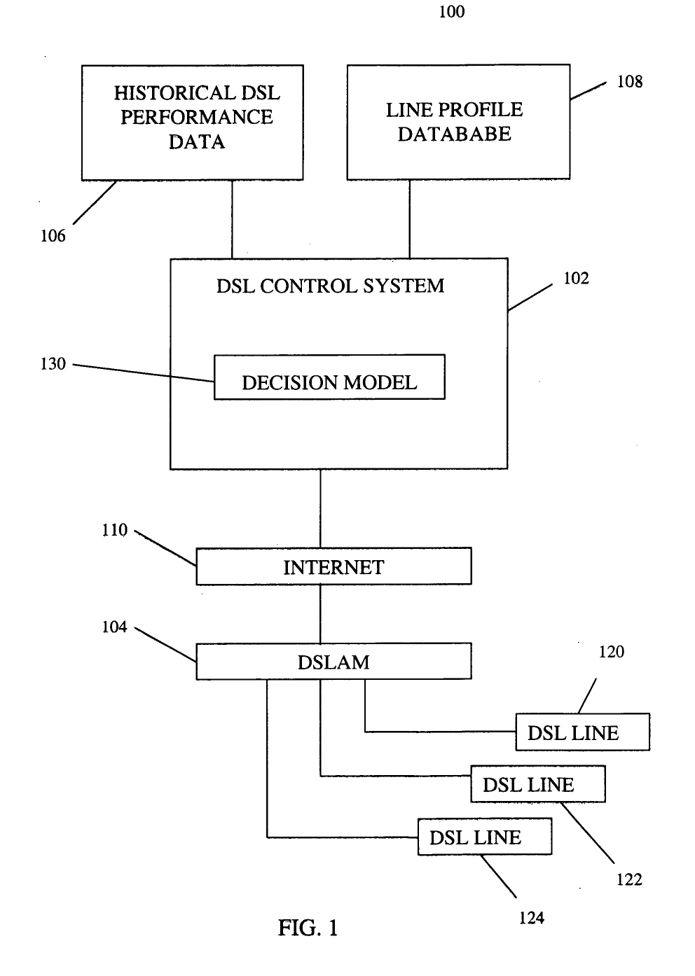

Referring to FIG. 1, a system 100 in accordance with an embodiment of the present invention is illustrated. The system includes a digital subscriber line (DSL) control system 102, an internet network core 110, and a Digital Subscriber Line Access Multiplexer (DSLAM) 104. The system also includes a line profile database 108 and a historical DSL performance database 106 coupled to the DSL control system 102. The line profile database comprises a variety of standard profiles used in error correction. The historical DSL performance database maintains the history of a customer usage, such as time of use and application used. The DSLAM 104 is connected to the internet 110 and connects to a plurality of DSL lines such as illustrated DSL lines 120, 122, and 124. The DSLAM receives signals the DSL lines and connects them to the internet using multiplexing techniques. The DSL control system 102 includes a decision model 130 for selecting an appropriate profile. A router 130, ATM switch 132, DSL modem 134 and customer premises equipment (CPE) 136 provide connectivity between the user and the Internet.

A computer-based system, such as the DSL control system 102, can be used to evaluate performance of a plurality of DSL lines. The set of DSL lines having degraded performance characteristics may be determined based on historical performance data 106 that is accessible to the computer-based system.

The DSL control system 102 may be implemented as a computer system that includes software to execute the decision model 130 including DSL selection logic. The DSL performance database 106 and the line profile database 108 may be implemented with standard computer database technology. The DSL control system 102 collects data from one or all of the modem, CPE, ATM switch, and router. The decision model uses the date collected to select a profile for a communication (DSL) line. The DSL control system characterizes the communication line usage time periods, the specific protocols used, the applications used and times of impulse noise. Based on these characteristics, the decision model recommends an appropriate downstream profile and an appropriate upstream profile with appropriate error correction profile applied for the upstream and an appropriate error correction profile applied for the downstream.

An error correction profile may reduce errors on the physical level, but actually make the quality of service the user experiences worse. For example, if a user is engaged in a voice application, a slower profile may be applied to reduce choppiness or jitter in the voice which occurs due to noise and lost packets. The same profile that was applied to the voice application might not be suitable for a data application where speed is more important. Conversely, applying a forward error correction profile to a line may speed up data transmission but actually degrade voice communication by introducing delays and echo into the voice. Thus, it is desirable to consider the application before applying a profile. The present invention provides visibility into the application and the impact of noise and selected profile on the application. The present invention provides a DSL control system 102 that non-intrusively (can be performed while the application is running) collects and measures statistics at one or more of the customer provided equipment (CPE), the ATM switch, the modem or router. The present invention determines the application, the physical impairment (noise) and the impact of the physical impairment on the application.

The decision model implements a number of rules upon which it makes its profiling decisions. For example, if the DSL control system has determined that a user is active on a 384 ADSL kilobit line and uses the line primarily for TCP data traffic, an example of a rule for this line might be to move the line to interleaved forward error correction if 1500 code violations occur during a prescribed time period. If the line is used for a voice application, however, the rule might be changed to move the line to forward error correction after 2,500 code violations within the same time period, but to apply a 5 millisecond delay instead or a 16 millisecond delay in the error correction. The decision model may also decide to collect more data before making a decision.

In one embodiment of the present invention, ADSL networks could use ATM as the protocol for the data link layer. Thus, when a user is using an ADSL line to transmit or receive data, the user data is packed in ATM cells. The more data the user transmits or receives, the more the ATM cell count increases. Different user applications typically display different patterns of ATM cell count increase. Thus, the application can be identified by monitoring the ATM cell counts. For example, while a user is web-browsing, typically the increase in cell count occurs randomly over time. When a user is involved in a streaming video application, however, the streaming video application generates a massive and steady cell count increase over time. ATM cell count patterns also depend on whether the user is engaged in uploading or downloading files. Downloading files (web-browsing, ftp) generates a large increase in downstream cell count and a relatively small increase in upstream cell count, while uploading files displays a large increase in upstream cell count and a relatively small increase in downstream cell count.

The port usage is further indicative of application type. Depending on the type of application being used, various ports experience increased traffic. For example, the ports used for web-browsing are not the same as the ports used for VoIP. Knowledge of the particular ports being used can therefore be used to determine the type of application used, and therefore the generally appropriate error correction for the application.

A Digital Subscriber Line Access Multiplexer (DSLAM) is a mechanism at a phone company's central location that links many customer DSL connections to a single high-speed ATM line. When the phone company receives a DSL signal, an ADSL modem with a plain old telephone service (POTS) splitter detects voice calls and data. Voice calls are sent to the public switched telephone system (PSTN), and data are sent to the DSLAM, where the data passes through the ATM to the Internet, then back through the DSLAM and ADSL modem before returning to the customer's personal computer (PC). DSLAM records ATM cell counts for each line and stores them in memory. By retrieving ATM cell counts and studying their patterns of increases, one can determine the usage of the line and decide a most suitable profile.

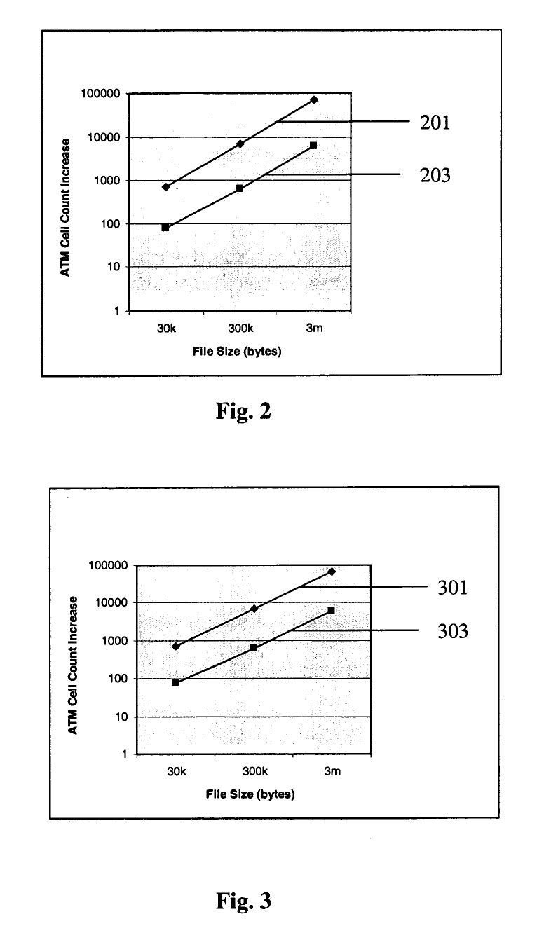

FIG. 2 shows a graph of upstream 203 and downstream 201 ATM cell counts during a period of downloading activity according to one aspect of the present invention. Testing is performed over a 15 minute period. An increase in ATM cell count can be seen in both upstreams and downstreams as file size increases. The downstream cell count 201 increases more quickly than upstream cell count 203 (with increasing file size). In this instance, large amounts of user of data are flowing from the Internet to the user, while the upstream is only being used for TCP packet acknowledgement.

FIG. 3 shows a graph of upstream 301 and downstream 303 ATM cell counts during a period of uploading activity during a 15 minute period according to one aspect of the present invention. If the user is using the line mainly for upstream applications, such as uploading photos or share media, downstream is only used for TCP packet acknowledgement and user data is flowing mainly from the user to the Internet. The upstream ATM cell counts 301 increases more than downstream ATM cell counts 303.

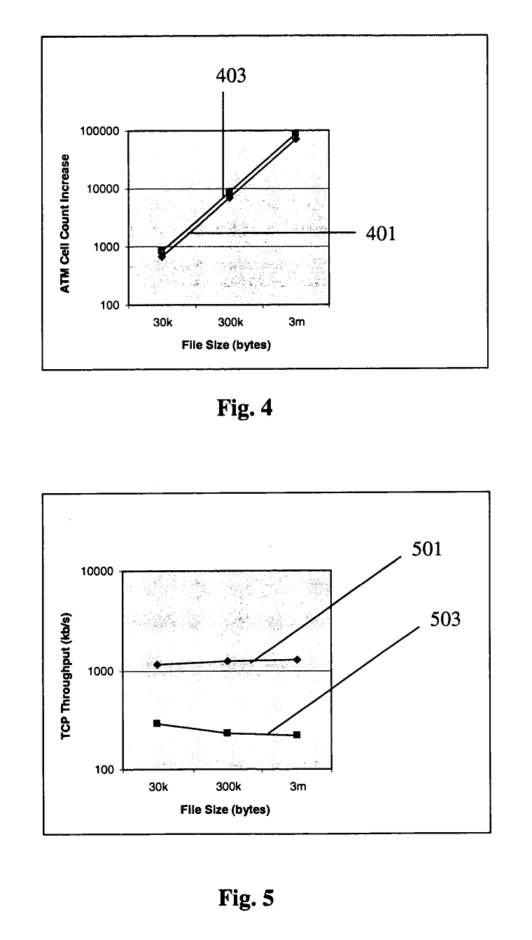

FIG. 4 shows the effect of the presence of impulse noise on a downstream ATM cell count during file transmission. Example cell counts are shown for a line without impulse noise 401 and with impulse noise 403. In order to transmit the same amount of user data in the downstream direction in the presence of impulse noise, the downstream ATM cell count increases. In the presence of noise, some of TCP packets are garbled and have to be retransmitted. Thus, additional ATM cells are required in order to transmit the same amount of data due to retransmission of the packets lost due to noise on the line. In the example shown in FIG. 4, impulse noise of 18 mV magnitude and 4 pulses per second is injected into the line. The injected noise creates about 3500 code violations in a 15-minute period. The downstream ATM cell count increases when transmitting files with the presence of impulse noise when compared to the ATM cell counts without impulse noise.

FIG. 5 shows the effect of impulse noise on TCP throughput. Throughput without noise 501 and in the presence of noise 503 is shown. The TCP throughput drops by approximately 50% in the presence of impulse noise. The line with noise should be addressed accordingly based on the user applications.

In addition to the characteristics displayed in FIGS. 2-5, different applications show unique characteristics in ATM cell counts. The characteristic of ATM cell counts of media streaming manifest a massive and steady increase and that of web browsing is random. The method of the present invention can use this information to correct performance in accord with the applications being used.

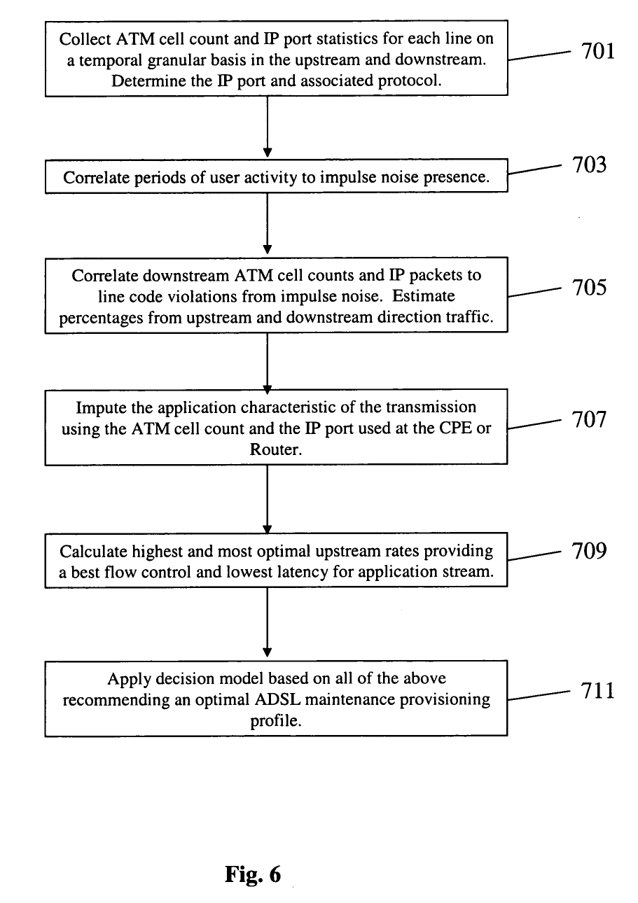

FIG. 6 shows a flowchart 700 of functions performed according to one example of the invention. In Box 701, ATM cell count and IP port statistics are collected for each line on a temporal granular basis in the upstream and downstream directions. A typical temporal granular size is, for instance, at 5-minute intervals. The IP port and associated protocol used in the connection to the communication line is determined. Data collection can be performed at several points, such as the CPE (Customer Premise Equipment) or at the ATM switch or IP router. For example, if the data collection point is the CPE, then the data collected could be on a per VLAN (Virtual Local Area Network) per service basis or per PVC (Permanent Virtual Circuit) per service basis.

In Box 703, periods of user activity are correlated to the periods of presence of impulse noise. Correlation between the occurrence of impulse noise and the user activity improves the precision to targeting proactive ADSL management. Lines that are impaired by impulse noise present during periods of user activity can be targeted.

In Box 705, downstream ATM cell counts and IP packets are correlated to line code violations (burst errors) from impulse noise. An estimate is made of the percent of bandwidth consumed by retransmissions in the downstream direction as well as the percentage of associated upstream bandwidth consumed for acknowledgements for flow control.

In Box 707, the ATM cell counts and the IP port used at the CPE or router are used to impute the application characteristic of the transmission. For example, a constant rate (greater than 20 kbps upstream and downstream over a period of 5 minutes) indicates the use of a voice or video stream. Alternatively, a highly variable rate (with downstream rate greater than upstream rate by a factor of at least 5) would indicate a TCP data stream. Additional collateral information from the IP port used at the CPE or Router is also used. In Box 709, the highest rates for the line that would provide the best flow control and lowest latency for the application stream are calculated.

In Box 711, a decision model is applied that recommends a ADSL maintenance profile (e.g., setting of interleaved forward error correction profile and associated depth—high, medium or low). Input to the model generally includes customer's activity periods, impulse noise intervals, application characteristics, and maximum upstream rate, among others. An example of a changed line profile includes a change to a reduced speed profile or to a channel interleaved profile to assist the performance of the problem DSL line selected for the application and noise associated with the DSL line.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method of managing a quality of service provided by a communication link, comprising:
a) estimating occurrence of errors on the communication link;
b) determining an application characteristic for the communication link; and
c) selecting a profile for the communication link based on the correlation of the occurrence of errors and the application to manage the quality of service provided by the communication link.

2. The method of claim 1, further comprising:
estimating user activity on the communication link periods wherein the correlating further comprises correlating the user activity to the occurrence of errors.

3. The method of claim 1, wherein said communication link further comprises a digital subscriber line (DSL).

4. The method of claim 1, wherein estimating occurrence of errors on the communication line further comprises determining an occurrence of code violations at a hardware level.

5. The method of claim 3, wherein the code violation is further characterized by a level of impulse noise.

6. The method of claim 1, wherein the application characteristic further comprises an application occurring at least one service level.

7. The method of claim 5, wherein the at least one service level further comprises one of i) layer 2, and, ii) layer 3 communication levels.

8. The method of claim 1, wherein the application characteristic further comprises at least one from a list of: i) upstream traffic, ii) downstream traffic, iii) ATM cell count, and, iv) IP port usage.

9. The method of claim 1, wherein profile further comprises an error correcting procedure optimally selected for said application.

10. The method of claim 1, wherein applying the profile further comprises using a decision model.

11. A computer readable medium containing instructions that when executed by a computer performs management of a quality of service provided by a communication link, comprising:
a) estimating occurrence of errors on the communication link;
b) determining an application characteristic for the communication link; and
c) selecting a profile for the communication link based on the correlation of the occurrence of errors and the application to manage the quality of service provided by the communication link.

12. The medium of claim 11, the method further comprising:
estimating user activity on the communication link periods wherein the correlating further comprises correlating the user activity to the occurrence of errors.

13. The medium of claim 11, wherein in the method the communication link further comprises a digital subscriber line (DSL).

14. The medium of claim 11, wherein in the method estimating occurrence of errors on the communication line further comprises determining an occurrence of code violations at a hardware level.

15. The medium of claim 13, wherein in the method the code violation is further characterized by a level of impulse noise.

16. The medium of claim 11, wherein in the method the application characteristic further comprises an application occurring on at least one service level.

17. The medium of claim 15, wherein in the method the at least one service level further comprises one of i) layer 2, and, ii) layer 3 communication levels.

18. The medium of claim 11, wherein in the method the application characteristic further comprises at least one from a list of: i) upstream traffic, ii) downstream traffic, iii) ATM cell count, and, iv) IP port usage.

19. The medium of claim 11, wherein in the method profile further comprises an error correcting procedure optimally selected for the application.

20. The medium of claim 11, wherein in the method applying said profile further comprises using a decision model.

21. A system for managing a quality of service provided by a communication link, comprising:
a control system that measures statistics for the communication link and determines an application characteristic for the communication link;
a database the contains profiles for the communication link; and
a decision model that selects a profile for the communication link based on the statistics and the application.

22. The system of claim 21, wherein the statistics comprise user activity and the occurrence of errors on the communication link.

23. The system of claim 21, wherein the communication link further comprises a digital subscriber line (DSL).

24. The system of claim 22, wherein occurrence of errors on the communication link further comprises code violations.

25. The system of claim 23, wherein the code violations are further characterized by a level of impulse noise.

26. The system of claim 21, wherein the application characteristic further comprises an application occurring on at least one service level.

27. The system of claim 26, wherein the at least one service level further comprises one of i) layer 2, and, ii) layer 3 network communication levels.

28. The system of claim 21, wherein the application characteristic further comprises at least one from a list of: i) upstream traffic, ii) downstream traffic, iii) ATM cell count, and, iv) IP port usage.

29. The system of claim 21, wherein profile further comprises an error correcting procedure optimally selected for the application.
